(19) United States
(12) Patent Application Publication
(10) Pub. No.: US 2014/0143063 A1
(43) Pub. Date: May 22, 2014

(54) METHODS AND SYSTEMS FOR PRESENTING GOODS AND SERVICES

(71) Applicants: Brian Albert Marino, St. Charles, MO (US); Thomas Ryan Koby, O'Fallon, MO (US)

(72) Inventors: Brian Albert Marino, St. Charles, MO (US); Thomas Ryan Koby, O'Fallon, MO (US)

(21) Appl. No.: 14/125,047

(22) PCT Filed: Jun. 8, 2012
(86) PCT No.: PCT/US12/41741

§ 371 Date: Feb. 7, 2014

Related U.S. Application Data
(60) Provisional application No. 61/495,265, filed on Jun. 9, 2011.

(51) Int. Cl. G06Q 30/02

(52) U.S. Cl. CPC G06Q 30/0277; G06Q 30/0269
USPC 705/14.66; 705/14.73

(57) ABSTRACT

A method of presenting a seller's goods or services to a consumer is provided. The method includes engaging the consumer in conversation with a representative of the seller while the consumer is accessing a webpage of the seller on an Internet browser of a consumer computing device. The method further includes directing the Internet browser to a presentation at a time selected by the representative using a representative computing device, wherein the presentation is configured to provide the consumer with information about at least one of goods and services of the seller.

### CROSS-REFERENCE TO RELATED APPLICATIONS

This application claims priority to U.S. Provisional Patent Application No. 61/495,265, which was filed on Jun. 9, 2011 and is incorporated herein by reference in its entirety.

### BACKGROUND

This disclosure relates generally to methods and systems for presenting goods/services and, more specifically, to methods and systems for marketing goods/services to consumers over the Internet.

Many known businesses advertise and sell goods/services on the Internet. At least some of these businesses have a webpage that showcases information about the goods/services using written descriptions, pictures, videos, etc. After a consumer has accessed the webpage, most businesses do not further engage the consumer beyond the actual content of the webpage, thereby relying on the content of the webpage alone to convert consumer traffic on the webpage into a sale of the goods/services showcased on the webpage. Often times, however, the content of the webpage is insufficient, in and of itself, to close the sale or otherwise accomplish the goals of the business or the consumer. Therefore, it would be useful to further engage the consumer in a manner that goes beyond the content of the webpage in order to increase the probability of converting the consumer's initial interest in the webpage into a sale of the goods/services showcased on the webpage or otherwise accomplish the goals of the business or the consumer.

### BRIEF DESCRIPTION

In one embodiment, a method of presenting a seller's goods or services to a consumer is provided. The method includes engaging the consumer in conversation with a representative of the seller while the consumer is accessing a webpage of the seller on an Internet browser of a consumer computing device. The method further includes directing the Internet browser to a presentation at a time selected by the representative using a representative computing device, wherein the presentation is configured to provide the consumer with information about at least one of goods and services of the seller.

### BRIEF DESCRIPTION OF THE DRAWINGS

FIG. 1 is a schematic illustration of an exemplary embodiment of a seller's webpage (e.g., the homepage of the seller's website);

FIG. 2 is a schematic illustration of a first user interface viewable by a representative of the seller via a first computer program configured to facilitate monitoring and engaging consumers accessing the seller's webpage shown in FIG. 1;

FIG. 3(a) is a flow chart illustrating an embodiment of a process for directing consumers from the seller's webpage shown in FIG. 1 to a presentation of the seller's goods/services;

FIG. 3(b) is a continuation of the flow chart shown in FIG. 3(a);

FIG. 4 is a schematic illustration of an exemplary embodiment of a presentation “login webpage” for use with the process shown in FIGS. 3(a) and 3(b);

FIG. 5 is a schematic illustration of an exemplary embodiment of a webpage (e.g., a “seller overview webpage”) of a presentation of the seller's goods/services to which a consumer is directed from the seller's webpage shown in FIG. 1;

FIG. 6 is a schematic illustration of an exemplary embodiment of another webpage (e.g., a “start building webpage”) of the presentation;

FIG. 7 is a schematic illustration of an exemplary embodiment of another webpage (e.g., a “walkthrough webpage”) of the presentation;

FIG. 8 is a schematic illustration of an exemplary embodiment of another webpage (e.g., a “benefits summary webpage”) of the presentation;

FIG. 9 is a schematic illustration of an exemplary embodiment of another webpage (e.g., a “sign-up webpage”) of the presentation;

FIG. 10 is a schematic illustration of a second user interface viewable by a seller via a second computer program configured to assist the seller in building the presentation shown in FIGS. 5-9;

FIG. 11 is a schematic illustration of a third user interface viewable by a representative of the seller via a third computer program configured to assist the representative in giving the presentation shown in FIGS. 5-9;

FIG. 12 is a schematic illustration of an exemplary embodiment of a computing device for use in building the presentation, viewing the presentation, and/or giving the presentation as described herein; and

FIG. 13 is a schematic illustration of an exemplary embodiment of a computing system having computing device(s) such as that shown in FIG. 12.

### DETAILED DESCRIPTION

Embodiments of methods and systems for presenting goods/services are described herein by way of example and not by way of limitation. The description clearly enables one of ordinary skill in the art to make and use the embodiments, including what is presently believed to be the best mode thereof. While the Figures illustrate embodiments of presenting a yacht club's goods/services, it is contemplated that the embodiments have general applicability in a broad range of other commercial, industrial, and/or consumer applications (e.g., the automobile industry, the hotel services industry, the educational industry, the real estate industry, the home furnishings industry, the insurance industry, etc.).

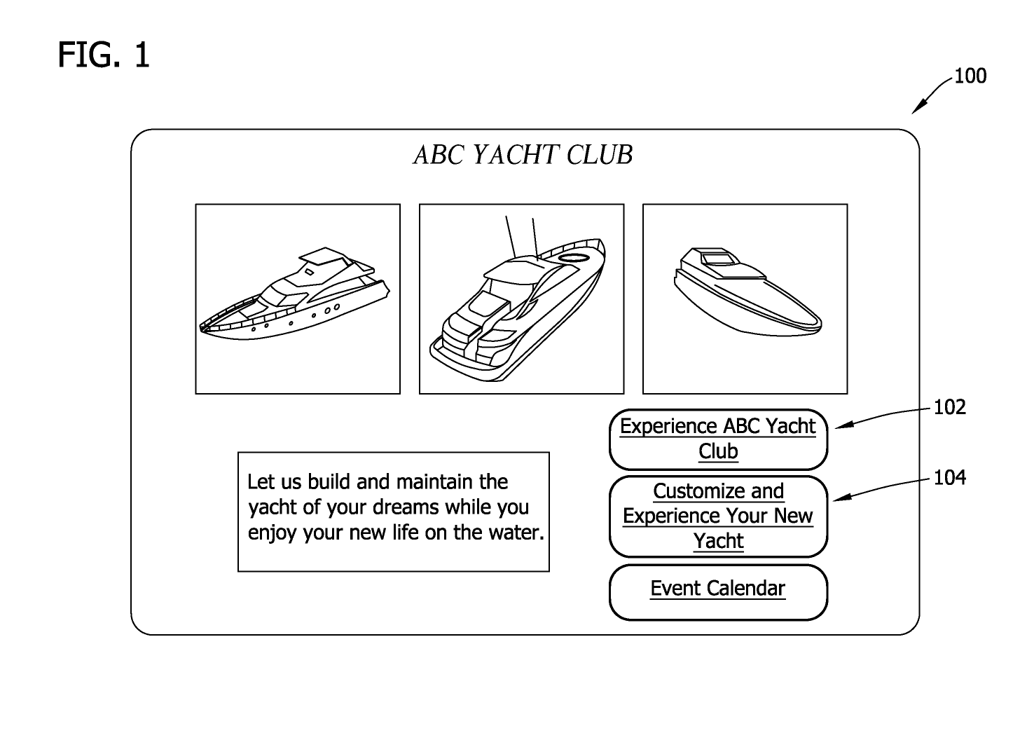

FIG. 1 is a schematic illustration of an exemplary embodiment of a seller's webpage 100 on the seller's website (e.g., the homepage of the seller's website). In the illustrated embodiment, the seller is ABC Yacht Club (hereinafter “the Club”), and the seller's business is building, storing, and maintaining custom yachts for its members, in addition to providing its members with yachting facilities and activities. In other embodiments, the seller may be any suitable person/entity selling any suitable goods/services. The illustrated webpage includes an “Experience ABC Yacht Club” selection button 102 and a “Customize and Experience Your New Yacht” selection button 104. If the “Experience ABC Yacht Club” selection button 102 is selected, the consumer is provided with a realistic presentation of the Club's facilities (e.g., the clubhouse, the yacht storage units, the marina, etc.). If the “Customize and Experience Your New Yacht” selection button 104 is selected, the consumer is provided with a realistic presentation of the Club's custom yacht building goods/services. While embodiments of a presentation of the Club's custom yacht building goods/services are described in more detail below, it should be noted that similar embodiments are also suitable for a presentation of the Club's facilities. Additionally, while the consumer may be directed to the presentation(s) via the seller's website, the consumer may also be directed to the presentation(s) via any suitable medium (e.g., by selecting an advertisement or other link provided on a social media webpage such as Facebook, LinkedIn, or Twitter).

It should be noted that the presentation of the Club's custom yacht building goods/services is not intended to facilitate selling custom yachts to consumers at the conclusion of the presentation, but the presentation is intended to enable a consumer to experience building a custom yacht as a member of the Club and thus encourages the consumer to become a member of the Club at the conclusion of the presentation. As such, the presentation guides the consumer through a “mock” custom yacht building experience in a relatively short amount of time (e.g., about fifteen minutes or so) to help the consumer understand some of the benefits associated with becoming a member of the Club (e.g., the wide variety of customizable yacht features, the quality/craftsmanship of the custom yachts, the cost savings over competitors' custom yachts, etc.). In some embodiments, the presentation may be configured to facilitate selling custom yachts at the conclusion of the presentation. In other embodiments, the presentation and associated systems/methods described herein may be configured to facilitate presenting any suitable goods/services to one party on behalf of another party for any suitable purpose, and the presentation and associated systems/methods described herein are not limited to the sale of goods/services from an entity to a consumer (e.g., the presentation may be used by a customer service representative to interactively lead an existing client of the insurance company through the process of updating his/her insurance policy).

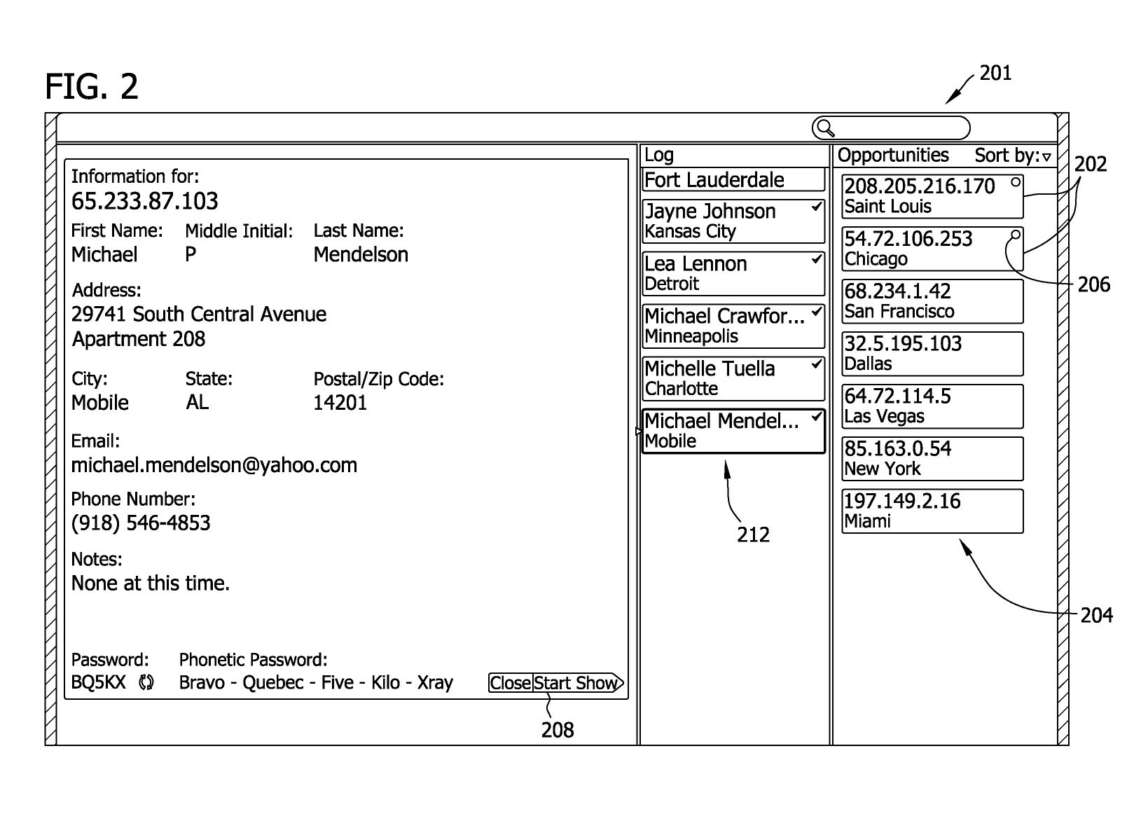

FIG. 2 is a schematic illustration of a first user interface 201 viewable by a representative of the seller via a first computer program configured to facilitate monitoring consumer traffic on the seller's website, selectively engaging the consumer while the consumer is accessing the seller's website (e.g., engaging the consumer at a time recommended by the first computer program based on a consumer's behavior or at a time selected solely within the representative's discretion), and/or directing the consumer from the seller's webpage to a presentation of the seller's goods/services.

In the exemplary embodiment, the first user interface provides the representative with a list 204 of internet protocol (IP) addresses 202 associated with consumer computing devices presently accessing the seller's website. The first computer program is also configured to monitor each action taken by consumers on the seller's website such that, when a consumer exhibits predefined behavior while accessing the seller's website (e.g., when the first computer program determines that a consumer has viewed information about a particular product a predefined number of times or for a predefined length of time), the representative is notified of such behavior via an instance indicator 206. After the instance indicator appears for a particular IP address (i.e., once a consumer has exhibited the predefined behavior on the seller's website), the representative may engage the consumer in a chat session via the first computer program (e.g., by selecting one of the IP addresses 202 in the first user interface) or via other suitable discussion medium. The representative may then gather personal information from the consumer, conduct a purchasing survey (as described below), and/or automatically direct the consumer to a presentation by selecting the “start show” button 208. In this manner, the representative is able to personally engage a consumer in discussion via the Internet browser that the consumer is using to access the seller's website, thereby seamlessly initiating a chat session and/or a presentation with the consumer at a time when the consumer is more likely to be interested in making a purchase. Additionally, the first computer program is configured to present the representative with a real-time log 212 of each consumer with whom the representative has engaged in discussion or to whom the representative has started giving a presentation, thereby enabling the representative to toggle between active engagements with various consumers (e.g., from a chat session with one consumer to a chat session with another consumer) and/or to view details of engagements that have already ended.

As used herein, the term “automatically direct” refers to the representative instructing the representative's computing device (e.g., via selection of the “start show” button) to control or otherwise lead the Internet browser of the consumer computing device into the presentation without any action or other intervention by the consumer or without any further action by the representative (e.g., without the consumer having to further interact with the Internet browser of the consumer computing device and without the representative having to provide the consumer with credentials such as a unique username/password for entry by the consumer into the presentation). Suitably, the Internet browser of the consumer computing device may be directed from one webpage to another webpage for the presentation, may be directed from one website to another website for the presentation, or may be directed to the presentation without changing from one webpage or website to another (e.g., the seller's webpage being accessed by the consumer may be actively revised via the representative's computing device to provide the consumer with the presentation).

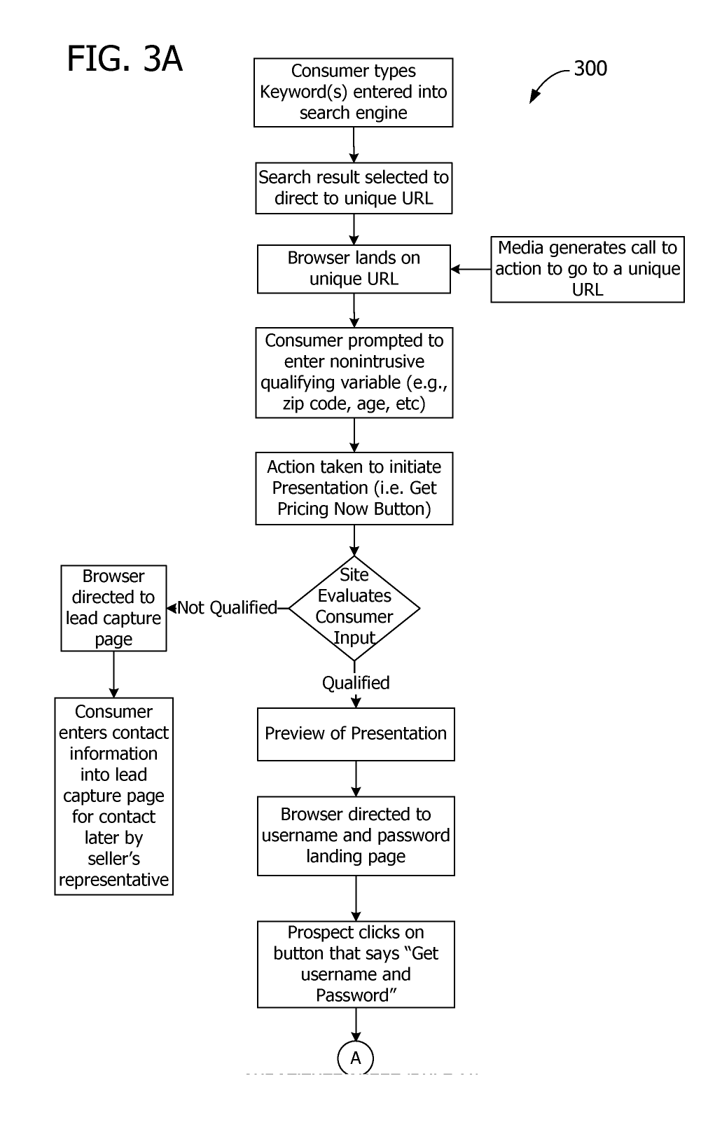

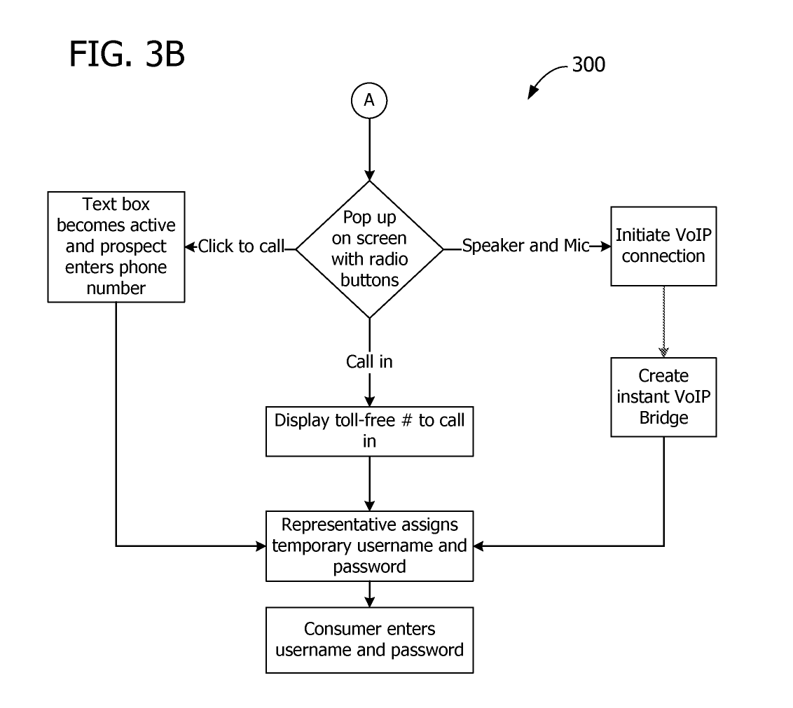

In another embodiment, if the representative is not able to engage the consumer in a chat session (e.g., due to a setting on the consumer's computing device such as, for example, a pop-up blocker operating or cookies being turned off on the consumer's computing device), the representative may commence with the lead capture process 300 shown in FIGS. 3(a) and 3(b). More specifically, when the consumer selects the “Customize and Experience Your New Yacht” selection button (FIG. 1) on the seller's website, the consumer may be prompted with at least one question regarding the compatibility of the consumer's computing device with the software of the presentation (e.g., the consumer may be prompted with a question as to whether the consumer's computing device has a pop-up blocker turned on, cookies turned on, an operable microphone, and/or a speaker for creation of an instant audio bridge that enables the consumer to speak directly with the representative using Voice over Internet Protocol (VoIP)). In other embodiments, the consumer's computing device may be automatically tested for compatibility with the software of the associated presentation, and the consumer may be instructed to take certain action in order to further engage in a conversation with the representative. Alternatively, the modes of discussion between the consumer and the representative may differ from webpage-to-webpage (e.g., the consumer may be able to speak with, write to, and/or view the representative on certain webpages but not others).

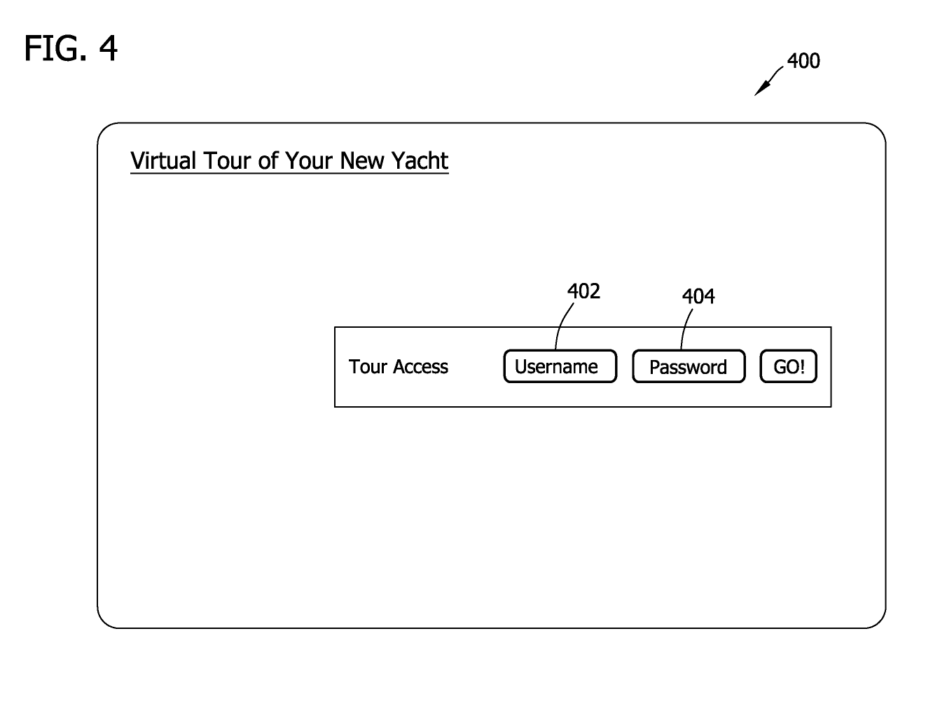

It should be noted that, in the exemplary embodiment, the webpages of the presentation (FIGS. 4-9) are on a third-party presentation website that is separate from, and linked to, the seller's website, and the webpages of the presentation are presented to the consumer by a third-party representative of the seller (e.g., by a representative from a third-party marketing firm that is an independent contractor of the seller). In other embodiments, the webpages of the presentation may be on the seller's website and/or may be presented to the consumer by any suitable representative of the seller (e.g., an internal customer service representative employed by the seller itself). Alternatively, the webpages of the presentation may be on any suitable website(s) and/or may be presented to consumers in any suitable manner. In the exemplary embodiment, the third-party's website includes sufficient information about the seller's goods/services (e.g., sufficient images, specifications, and pricing) to enable the representative to conduct the presentation completely within the third-party's website (i.e., without having to access information from the seller's website during the presentation), which facilitates a more seamless and secure presentation and sale of the seller's goods/services to the consumer. In alternative embodiments, the third party's website may be designed to retrieve data, in real-time, from the seller's website and/or other sources as that data is requested during the presentation by the consumer and/or the representative. Additionally, the consumer and/or the representative may have differing abilities to interact with the presentation website. For example, in the exemplary embodiment, the representative has full interactive ability throughout the presentation, while a pre-determined, limited amount of consumer interactive ability has been defined for each of webpage of the presentation (i.e., the seller and/or the third-party have determined, on a webpage-by-webpage basis, an amount of consumer interactive ability that desirably facilitates yielding a sale at the end of the presentation). In other embodiments, the consumer may be given full interactive ability on all webpages of the presentation.

Before granting the consumer access to the webpages of the presentation website (e.g., before directing the consumer away from the seller's website via the “start show” button of the first user interface), the representative may conduct a brief purchasing survey, asking the consumer questions to assess the likelihood that the goods/services presented during the presentation are suited for the consumer's skills, interests, and/or goals. For example, in the exemplary embodiment, the representative may ask the consumer how long the consumer has been yachting, whether the consumer has owned a yacht in the past, how much money the consumer anticipates spending on purchasing, storing, and maintaining a yacht in the next five years, how often the consumer anticipates participating in yachting activities (e.g, races, expeditions, etc.), and/or how much money the consumer anticipates spending on yachting activities in the next five years. If the representative determines that the seller's goods/services are not suited for the consumer, the representative may explain as much to the consumer, and the consumer may decide not to proceed with the presentation. If the representative determines that the seller's goods/services of the presentation are suited for the consumer, the representative proceeds with the presentation as set forth below.

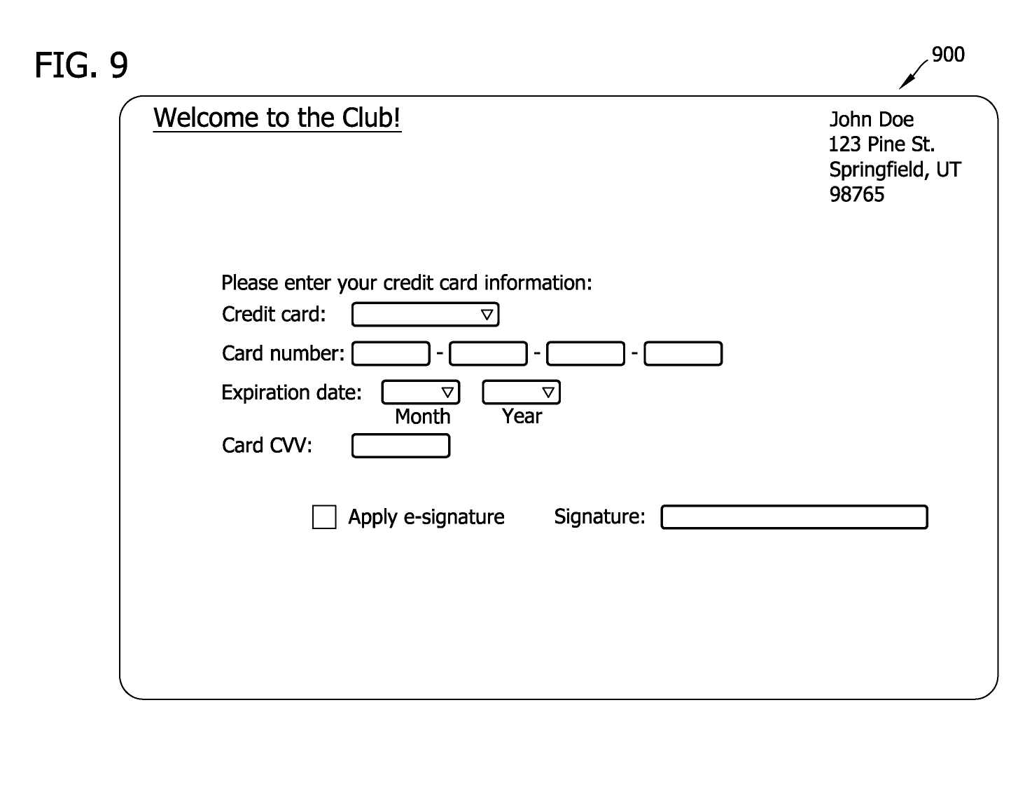

Also, before granting the consumer access to the webpages of the presentation website (e.g., before automatically directing the consumer's Internet browser away from the seller's website via the “start show” button on the first user interface), the representative may gather personal information from the consumer (i.e., name, age, address, profession, etc.). If the consumer decides to become a member of the Club at the conclusion of the presentation, the personal information gathered at the outset of the presentation may be used to at least partially complete the membership sign-up form(s) (FIG. 9) presented to the consumer at the end of the presentation, thereby expediting the membership sign-up process. The personal information and/or the answers to the purchasing survey gathered at the outset of the presentation may also be stored along with interaction data logged during the presentation (as described in more detail below) to facilitate building a database of information relating to consumer purchasing tendencies and/or representative selling techniques (e.g., to facilitate presenting the representative with a real-time, evolving presentation strategy during future presentations, as described in more detail below).

After conducting the purchasing survey and gathering personal information, the representative selects the “start show” button on the first user interface or provides the consumer with temporary credentials for entering the presentation (e.g., a temporary username and/or a temporary password generated by the first program and shown on the first user interface). If the representative provides the consumer with temporary credentials (e.g., if the first program is unable to automatically direct the consumer into the presentation due to a setting on the user's computing device), the consumer may be asked to access a “login webpage” 400 (FIG. 4) when the “start show” button is selected, and the consumer can then enter the temporary username into the “username” field 402 and/or the temporary password into the “password” field 404 (i.e., the consumer is allowed full interactive ability on the login webpage in the exemplary embodiment). At the conclusion of the presentation, if the consumer decides to become a member of the Club, the temporary credentials may be used as a first set of permanent credentials by which the consumer may initially access his/her account with the seller. On the other hand, if the consumer decides not to become a member of the Club at the conclusion of the presentation, the temporary credentials may be permanently discarded (i.e., no longer useable by consumers to enter the presentation) and/or may be stored in conjunction with the interactive data gathered during the presentation. It should also be noted that, while the presentation is described herein as presenting a single seller's goods/services to a single consumer, the presentation may be suitably configured for simultaneously presenting one or more consumers with the goods/services of one or more sellers. Also, the representative may provide the consumer with access to the presentation in any suitable manner (e.g., by e-mailing or otherwise providing the consumer a link to the presentation webpage, by providing the consumer with a unique alphanumeric sequence (e.g., a “token”) for use by the consumer's Internet browser to enable access to the presentation webpage, etc.)

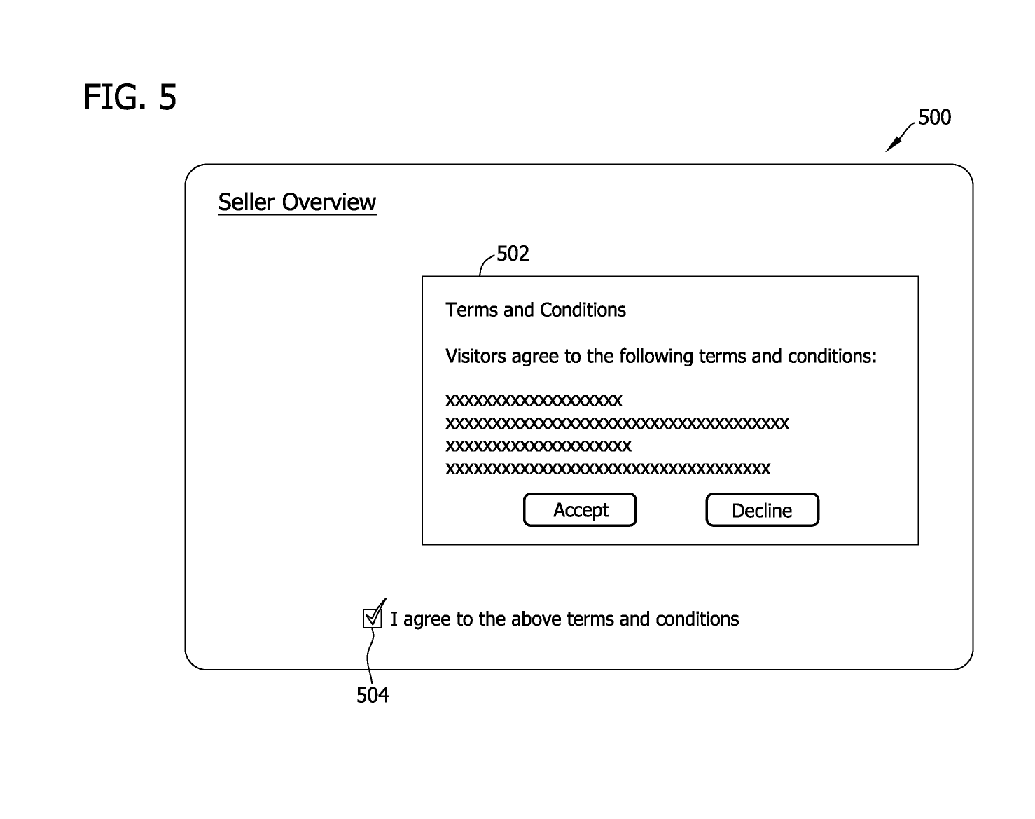

FIG. 5 is an image of an exemplary “seller overview” webpage 500 of the presentation. Directly from the seller's webpage (FIG. 1) or after the consumer enters the temporary credentials into the login webpage (FIG. 4), the consumer is directed to the seller overview webpage. The seller overview webpage includes a window 502 in which the consumer may be shown a video featuring some of the benefits associated with becoming a member of the Club (e.g., the video may show images of the Club's facilities, images of custom yachts built for existing members of the Club, and/or images of existing members and their families enjoying activities at the Club). After the video concludes, the window may be used to provide the consumer with terms/conditions associated with the presentation. In order to proceed, the consumer must accept the terms and conditions by selecting a checkbox 504 (i.e., the consumer is granted full interactive ability on the seller overview webpage in the exemplary embodiment).

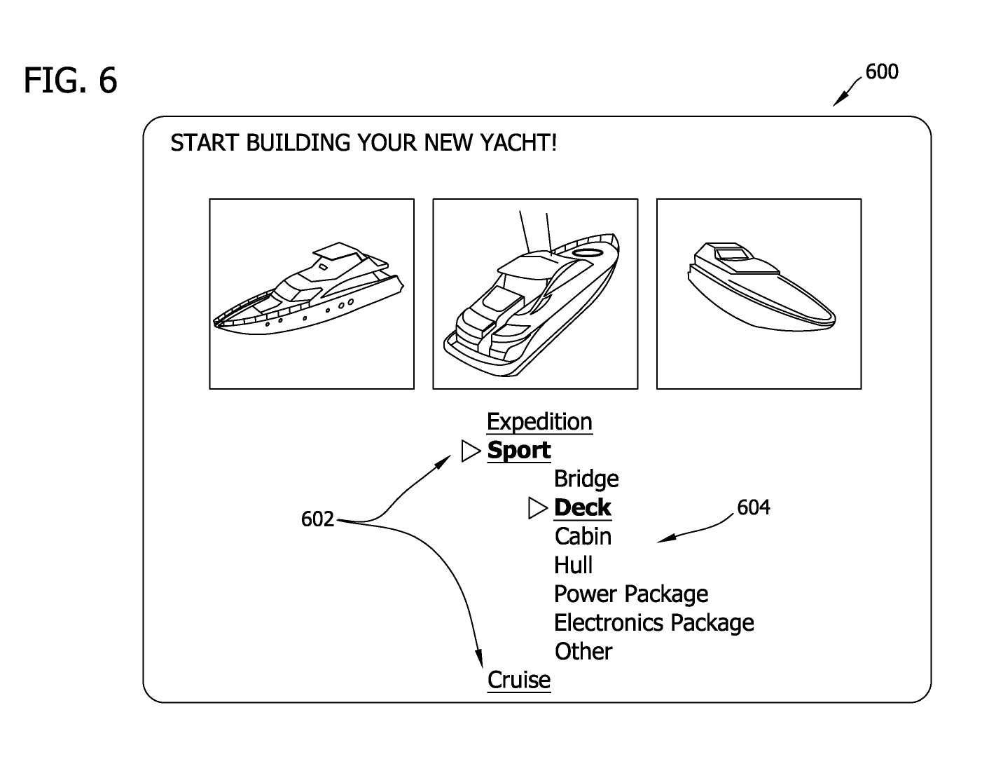

FIG. 6 is an image of an exemplary “start building webpage” 600 of the presentation. After the consumer accepts the terms and conditions on the seller overview webpage (FIG. 5), the consumer is directed to the start building webpage. The start building webpage may present the consumer with a list of product types 602 that are available through the seller and may also present the consumer with a list of product subtypes 604 associated with each product type. The consumer may be presented with any suitable product types and/or product subtypes. As referred to herein, the term “product” is not intended to refer only to tangible items but, rather, is intended to broadly refer to any suitable goods or services offered by a seller.

In the exemplary embodiment, the consumer is not granted interactive ability on the start building webpage, meaning that the consumer must communicate his/her interests to the representative, and the representative must then interact with the start building webpage on behalf of the consumer. As such, the representative has more control over the pace of the presentation because the representative can better assist the consumer in choosing to be presented with goods/services that are most compatible with the consumer's answers during the purchasing survey, thereby facilitating the overall appeal of the presentation experience to the consumer and the likelihood that the presentation will yield a sale to the consumer.

In the exemplary embodiment, the consumer is presented with the following product types that are available through the Club: an expedition yacht; a sport yacht; and a cruise yacht. Because the consumer has expressed an interest in, or the representative has recommended, the sport yacht product type, the representative has selected the sport yacht product type. With the selection of the sport yacht product type appear the product subtypes associated with the sport yacht product type, namely the bridge, the deck, the cabin, the hull, the power package, and the electronics package, among others. Because the consumer has expressed an interest in, or the representative has recommended, customizing the deck product subtype first, and the representative has therefore selected the deck product subtype.

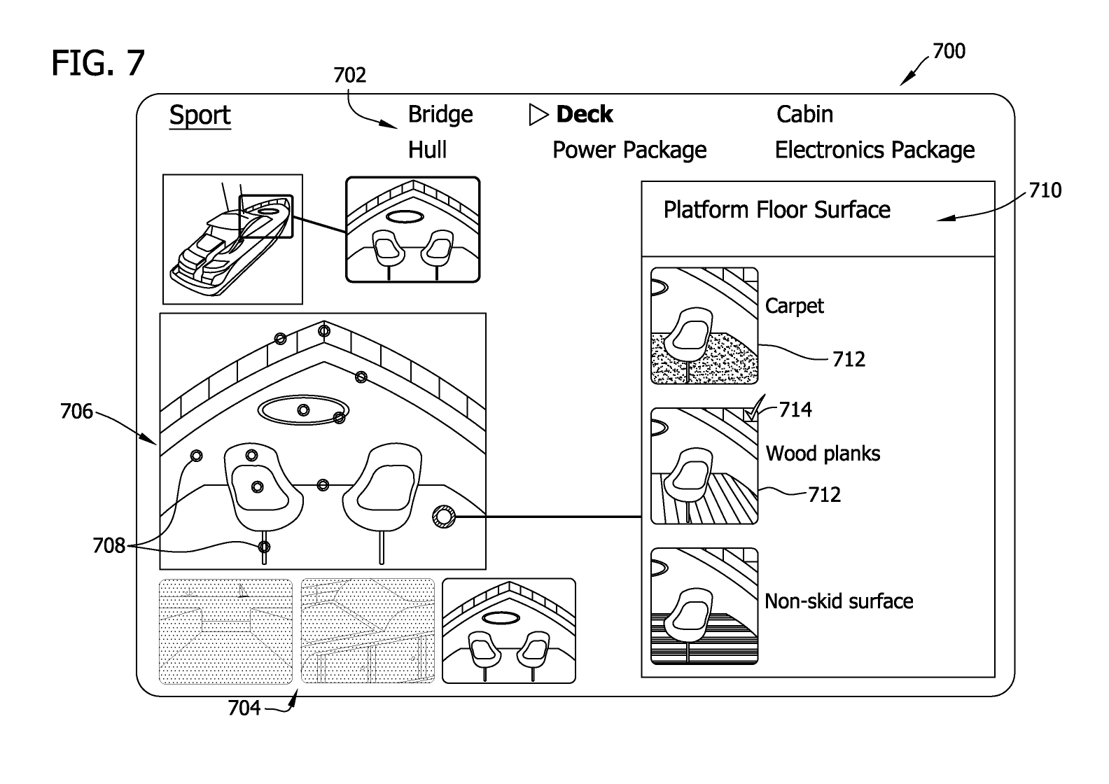

FIG. 7 is an image of an exemplary “walkthrough” webpage 700 of the presentation. After the representative selects the product subtype on the start building webpage, the consumer is directed to the walkthrough webpage. As described in more detail below, the consumer has been granted limited interactive ability on the walkthrough webpage in the exemplary embodiment. In other embodiments, the consumer may suitably be granted more or less interactive ability than described below.

Near the top of the walkthrough webpage, a list 702 of the product subtypes is provided. In the exemplary embodiment, the product subtypes in the list are the same as the products subtypes listed on the start building webpage, which facilitates enabling the representative to more seamlessly guide the consumer from one product subtype to another product subtype without having to move back to the start building webpage. Additionally, upon accessing the walkthrough webpage, the product subtype chosen by the consumer on the start building webpage is highlighted (e.g., bolded) and indicated by an arrow in the list of product subtypes provided on the walkthrough webpage. The consumer cannot interact with the list of product subtypes on the walkthrough webpage for similar reasons to those described above.

Near the bottom of the walkthrough webpage, at least one thumbnail viewing window 704 is provided. After a product subtype has been selected from the start building webpage or the walkthrough webpage, image(s) of the product subtype become visible in the thumbnail viewing window(s). In some embodiments, multiple images may appear for certain product types, and each of the images presents a different perspective view of the product subtype. In other embodiments, any suitable number of images having any suitable viewpoints may be provided for each product subtype.

Between the list of product subtypes and the thumbnail viewing windows, a main viewing window 706 is provided for enlarged viewing of images presented in the thumbnail viewing windows. For each product subtype, one of the images in the thumbnail viewing windows has been preselected as a default image to be initially presented in the main viewing window upon selection of that product subtype from the start building webpage or the list near the top of the walkthrough webpage. In the exemplary embodiment, the thumbnail viewing window having the image that is currently being viewed in the main viewing window is represented differently than the thumbnail viewing windows having images that are not currently being viewed in the main viewing window (e.g., the thumbnail viewing windows having images that are not currently being viewed in the main viewing window are more translucent in appearance, while the thumbnail viewing window having the image currently being viewed in the main viewing window is more transparent). To change the image that is being presented in the main viewing window, the representative may select amongst the thumbnail viewing windows, thereby rendering the newly selected thumbnail viewing window more transparent and the previously selected thumbnail viewing window more translucent. For similar reasons as those described above, the consumer has not been granted interactive ability with respect to selecting the thumbnail viewing windows.

In the exemplary embodiment, each product subtype may have any suitable number of associated images, and the number of images associated with one of the product subtypes may be different than the number of images associated with another one of the product subtypes (e.g., depending upon the desired number of viewpoints). In the exemplary embodiment of the walkthrough webpage, the number of thumbnail viewing windows (i.e., three) remains the same amongst the product subtypes, but other embodiments of the walkthrough webpage may have the number of thumbnail viewing windows being dependent upon the number of images associated with each individual product subtype. In the exemplary embodiment, if the number of thumbnail viewing windows is greater than the number of images associated with a product subtype (i.e., when at least one of the thumbnail viewing windows is not occupied by an image associated with a product subtype), the unoccupied thumbnail viewing window is filled with an advertisement for the seller. In other embodiments, thumbnail viewing windows that are not occupied by images associated with a product subtype may contain any suitable filler material.

In the exemplary embodiment, each image of a product subtype has at least one associated “hotspot” 708 assigned to at least one customizable feature of the product subtype that is visible in the image (e.g., a hotspot may appear over a railing, a seating area, or a floor surface in an image of the deck of the sport yacht to indicate to the consumer that the feature of the deck is customizable). In the exemplary embodiment, when an image is viewed in a thumbnail viewing window, the associated hotspot(s) are not visible to the consumer. However, when that same image is viewed in the main viewing window (i.e., when the image is the default image or when the thumbnail viewing window has been selected by the representative), the hotspot(s) are visible to the consumer, but only in the main viewing window.

Each image may have any suitable number of associated hotspots, and each hotspot may be selected to provide the consumer with additional information about the related customizable feature, as described below. However, the consumer is not granted interactive ability with respect to selecting the hotspots for the reasons described above. Rather, the consumer must convey his/her interest in a customizable feature to the representative, and the representative may then select the associated hotspot on behalf of the consumer. When a hotspot has been selected by the representative, the hotspot is highlighted (e.g., enlarged). If the representative selects another hotspot associated with the same image, the image does not refresh but, rather, the newly selected hotspot becomes highlighted and the previously selected hotspot ceases to be highlighted, thereby providing a more seamless virtual experience. In other embodiments, the hotspots may be selectable in any suitable manner and may have any suitable appearances.

To the right of the main viewing window is a product list 710 having a plurality of product viewing windows 712. When a hotspot is selected in the main viewing window by the representative, images of products that are available through the seller for the associated customizable feature become visible to the consumer in the product viewing windows. The product images are retrieved from a database of the third-party (or any other suitable location), and the order in which the product images appear in the product list may be determined via either random selection from the database or prioritized selection from the database. Each product image shows the product in the environment of the customizable feature, as the customizable feature appears in the image of the product subtype shown in the main viewing window. For example, if the hotspot associated with the customizable platform floor surface is selected in the main viewing window, products that are available for the platform floor surface (e.g., carpet, wood planks, or non-skid surface) are shown in the product viewing windows via product images having the same environment as the deck shown in the main viewing window. In other embodiments, the product images may not present the products in the same environment in which the associated customizable feature is presented in the main viewing window (e.g., the images of the platform floor surface products may be sized to showcase the grains in the wood planks or the texture of the carpet such that no environment of the deck is visible in the product images).

In one embodiment, product notes may appear in the product list for each product (e.g., manufacturer, model, suggested retail price, price when purchased through the Club, savings figures associated with purchasing the product through the Club, etc.). If the consumer desires to view products in addition to those that are shown in the product list, the representative may refresh the product list such that a different set of products are shown. As such, the representative is able to quickly and repeatedly refresh the product list in order to showcase the variety of products offered by the seller for each customizable feature. In the exemplary embodiment, each of the product viewing windows includes a checkbox 714, and the consumer is granted the interactive ability to select the checkboxes of one or more products that are of interest to the consumer. The representative may also select checkboxes for the consumer. In other embodiments, the products may be presented and/or selected in any suitable manner. Additionally, the images presented in the main viewing window, the thumbnail viewing window(s), or the product viewing window(s) may be two-dimensional images, three-dimensional images, or videos of the product types, product subtypes, or products.

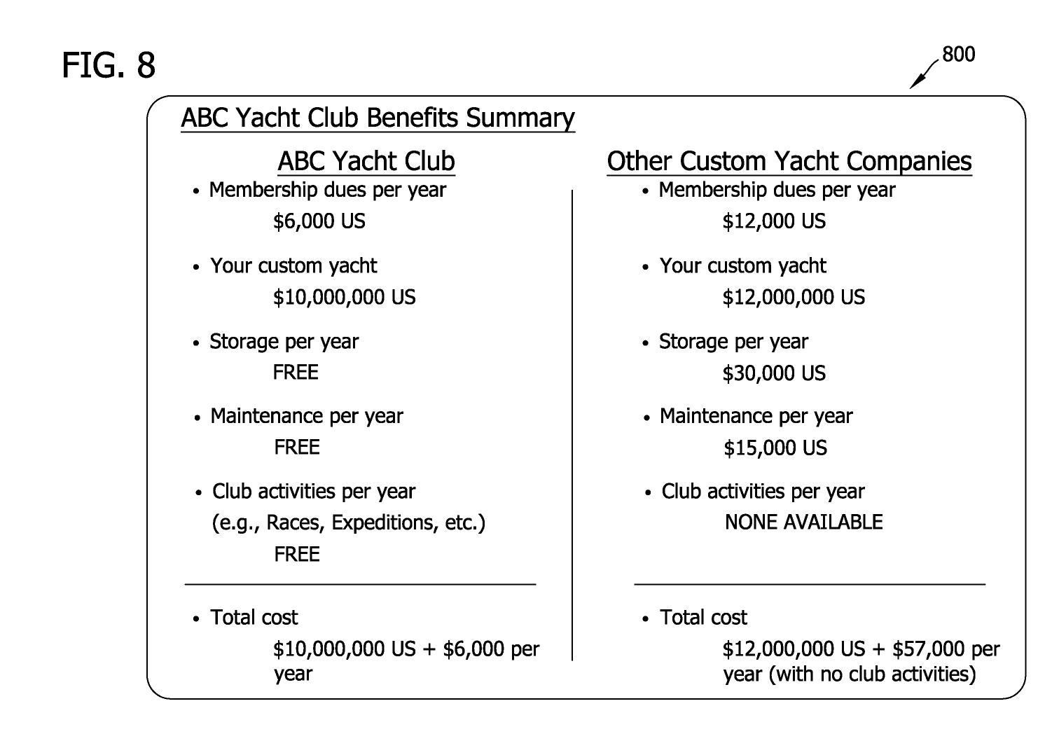

FIG. 8 is an image of an exemplary “benefits summary” webpage 800 of the presentation, and FIG. 9 is an image of an exemplary “sign-up” webpage 900 of the presentation. After the consumer has completed the presentation, the representative directs the consumer to the benefits summary webpage to better explain the benefits of becoming a member of the Club in view of the consumer's presentation experience. In the exemplary embodiment, the products selected from the product list by the consumer/representative are tracked throughout the presentation. At the conclusion of the presentation, the consumer is presented with a calculation of the total cost-savings associated with the consumer's “mock” customized yacht, in addition to other benefits associated with becoming a member of the Club (e.g., free yacht storage, free yacht maintenance, and free yachting activities). If the consumer is interested in purchasing a membership to the Club after having viewed the benefits summary webpage, the consumer is directed to the sign-up webpage in order to obtain payment information and any additional personal information that is needed to finalize a membership account for the consumer. In some embodiments, the consumer may be able to sign documentation via a digital signature or any other suitable method. In other embodiments, the consumer may be provided a digital receipt from payment processing and/or may be given the option to print or receive an email containing proof of membership (e.g., ID cards, insurance cards, etc.).

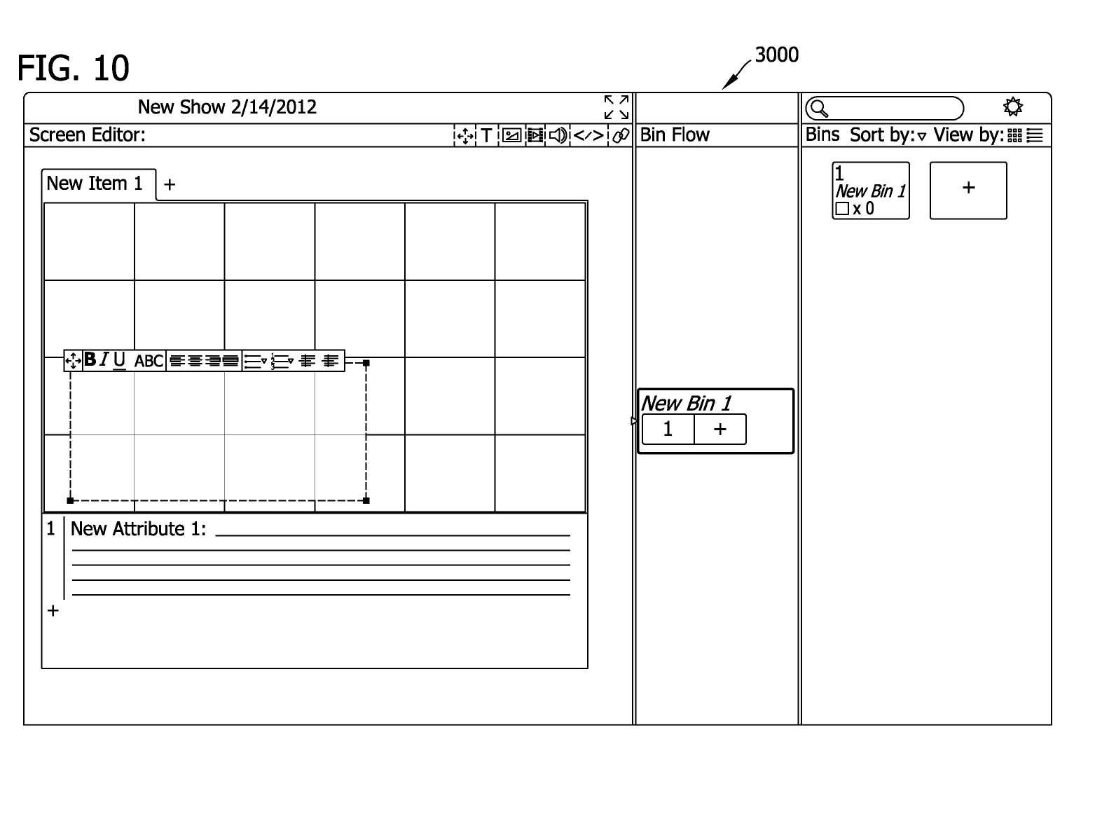

FIG. 10 is a schematic illustration of a second user interface 3000 viewable by a seller via a second computer program configured to assist the seller in building the presentation. Using the second user interface, the seller is able to easily name the presentation, create each webpage of the presentation by selecting text, images, videos, sounds, etc. and arranging them in a desired presentation format. The seller is also able to easily embed Internet links into the presentation for directing consumers to websites outside of the presentation itself. Each customizable presentation option is associated with prewritten computer code, thereby enabling the seller to customize the presentation without having to actually write the computer code on which the presentation is built. The seller is therefore provided with a self-help tool for more easily and cost-effectively building an interactive presentation that may be delivered to consumers by a third-party representative via a third-party website that is separate from the seller's website, as described in the exemplary embodiment.

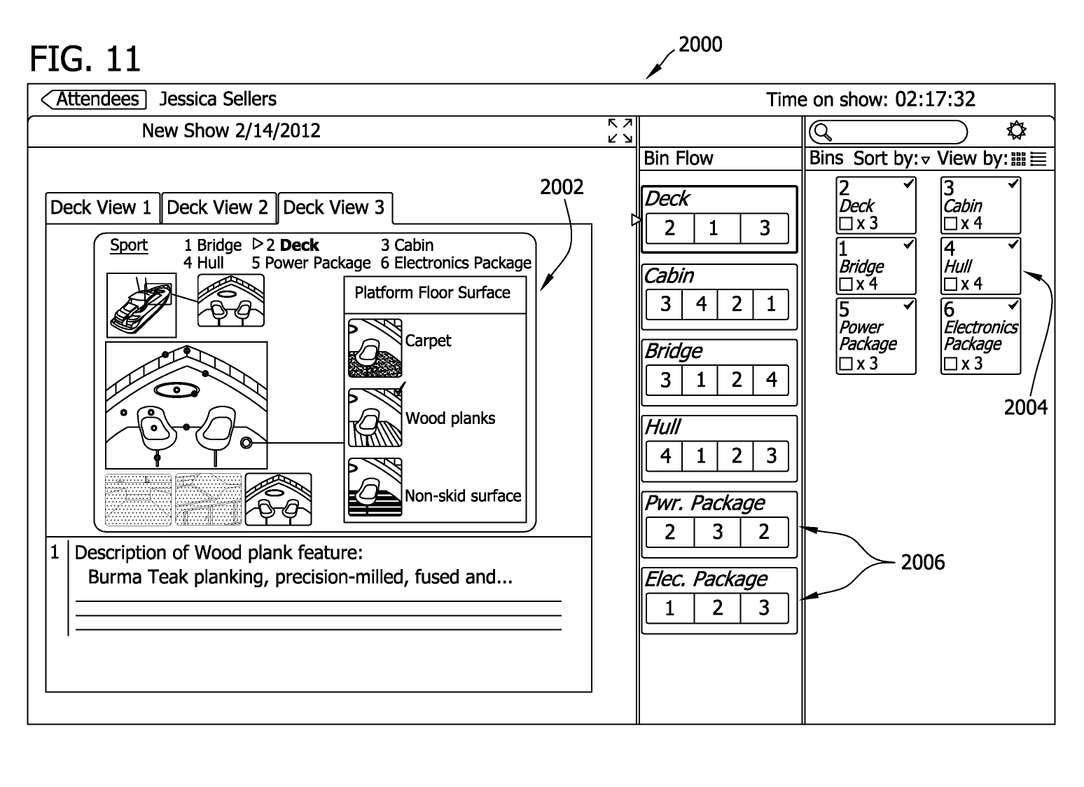

FIG. 11 is a schematic illustration of a third user interface 2000 viewable by a representative of the seller via a third computer program configured to assist the representative in giving the presentation. As the representative is guiding the consumer through the presentation described above, the information viewable by the consumer may be different than the information viewable by the representative via the third user interface. In the exemplary embodiment, the third user interface provides the representative with a view 2002 of the presentation from the standpoint of the consumer (e.g., a view of the presentation as it appears in the consumer's Internet browser), in addition to information that is not viewable by the consumer (e.g., information relating to the seller's profit-margins and/or information relating to an evolving presentation strategy, which is described in more detail below).

In some embodiments of the presentation described above, data relating to each consumer's presentation experience may be logged by the third computer program. For example, in one embodiment, data relating to each consumer's progression through the presentation (e.g., interactions of the consumer and/or the representative with the start building webpage and/or the walkthrough webpage), data relating to each consumer's personal information, and/or data relating to each consumer's answers during the purchasing survey (collectively the “presentation data”) may be stored. The presentation data is evaluated by the third computer program in order to facilitate determining purchasing tendencies of similar consumers and sales techniques that are suitable for those purchasing tendencies. In other embodiments, any suitable data may be logged during the consumer's presentation.

In the exemplary embodiment, the third computer program functions as an intelligent Customer Relationship Management module (CRM) for assisting the representative in guiding each consumer through the presentation described above. The CRM provides the representative with a strategy for properly guiding the consumer through the presentation in a manner that is more likely to yield a sale at the end of the presentation. The purchasing tendencies of previous consumers and the sales techniques identified for those purchasing tendencies (as described above) are used to configure the CRM for providing such a presentation strategy to the representative. Specifically, as a representative guides a new consumer through a presentation, the CRM is configured to assess the new consumer's presentation data in view of the presentation data of previous consumers to prepare, and continuously update, a presentation strategy for the representative to use on the new consumer (i.e., the CRM provides the representative with a presentation strategy that automatically evolves in real-time throughout the presentation in response to the new consumer's presentation data, which is also logged for use in future configuration of the CRM for giving the presentation to other new consumers).

The following is an example of an evolving presentation strategy that may be automatically provided to a representative by the CRM when the representative is guiding a new consumer through the presentation. If the new consumer accesses the walkthrough webpage and initially inquires into customizable features A and C, the CRM instructs the representative as to whether the representative should next bring the consumer through customizable features D, E, F, and then G; bring the consumer through customizable features F, D, G, and then E; or bring the consumer straight to feature G without wasting time on features D, E, and F. By comparing the logged presentation data of the new consumer (e.g., the new consumer's personal information, purchasing survey answers, and/or interests in features A and C) to the correlated presentation data of previous consumers, the CRM instructs the representative to that a sale is more likely if the representative next guides the new consumer through features F, D, G, and then E. Upon doing so, the consumer immediately inquires into feature F, the presentation strategy evolves again and instructs the representative to then skip feature D and bring the consumer straight to feature G and to feature E. After that, the consumer inquires into feature G, and the CRM then instructs the representative to try to close the sale without proceeding to other features. As such, in some embodiments of the presentation, the CRM facilitates providing evolving presentation strategies that are unique to each consumer (i.e., no two consumer experiences will be exactly the same). While the representative is provided with this evolving presentation strategy in real-time from the CRM, the consumer cannot view the presentation strategy and does not know that the representative is utilizing the presentation strategy. Of course, in some embodiments, the representative may alter the presentation strategy as he/she sees fit throughout the presentation if the representative desires to do so.

In the exemplary embodiments, the evolving presentation strategy may be manifested in the third user interface (FIG. 10) via the third computer program automatically resorting or prioritizing a list 2004 of product subtypes and, for each product subtype, automatically resorting or prioritizing a list 2006 of associated customizable features in accordance with the evolving presentation strategy, thereby enabling the representative to view the lists as a guide for an effective presentation strategy recommended by the CRM in order to close the sale (e.g., the representative can view the lists as a guide to the flow or order by which the representative should lead the consumer through the various product subtypes and/or the various customizable features associated with each product subtype in order to close the sale).

Provided below is an example of a consumer experiencing the presentation of ABC Yacht Club, as described above. The consumer first accesses the Club's website (e.g., the Club's homepage shown in FIG. 1), and the consumer is personally engaged by the representative (e.g., via chat) after exhibiting predefined behavior while viewing the seller's website or after selecting the “Customize and Experience Your New Yacht” selection button. The consumer may then be directed to the login webpage of the third-party presentation website, or the consumer's computer may be tested for compatibility with the presentation software. The representative may then gather some personal information from the consumer (e.g., name, address, profession, etc.), and the representative may conduct a brief purchasing survey with the consumer to assess the consumer's skills, interests, and goals with respect to joining a yacht club. If the representative believes that the consumer's skills, interests, and goals are suitable for membership into the Club after gathering personal information and conducting the purchasing survey, the representative selects the “start show” button on the first user interface or the consumer is given temporary credentials for entry into the “login webpage.” The consumer is then granted access to the presentation and is directed to the seller overview webpage, where the consumer is shown a promotional video about the Club. After the video, the consumer is presented with terms and conditions associated with proceeding with the presentation.

After the consumer accepts the terms and conditions on the seller overview webpage, the consumer is directed to the start building webpage (FIG. 6). The representative engages in a conversation with the consumer regarding whether the consumer prefers expedition, sport, or cruise yachting (i.e., whether the consumer would prefer to use an expedition, sport, or cruise yacht for the subject of the “mock” customization experience). During the purchasing survey, the representative may have also gathered information that is relevant to the consumer's preference amongst expedition, sport, or cruise yachts. In accordance with the consumer's interest in sport yachting, the representative selects the “sport” product type. Then, associated product subtypes (i.e., a list of general locations and equipment packages on a sport yacht) appear on the start building webpage, and the representative asks the consumer if the consumer has a preference as to which general location and/or equipment package the consumer would like to experience first. Again, the representative may have gathered information from the consumer during the purchasing survey that indicates which of the product subtypes would be of most interest to the consumer. Because the consumer expresses an interest in viewing the deck, the representative selects the “deck” field on the start building webpage.

After the representative selects the deck on the start building webpage, the consumer is directed to the walkthrough webpage (FIG. 7). Various views of the deck from the vantage point of the consumer standing on the deck of the sport yacht appear in the thumbnail viewing windows of the walkthrough webpage (e.g., a view of the forward deck, a view of the aft deck, and a view of the port side deck). The image of the forward deck has been chosen by the seller and/or the third-party as the default image, and it initially appears in the main viewing window. After viewing the image of the forward deck in the main viewing window, the consumer expresses interest in customizing the platform floor surface, and the representative selects the hotspot associated with the platform floor surface. The hotspot for the platform floor surface is then highlighted in the main viewing window, and various products for customizing the platform floor surface appear in the product list. The consumer likes and selects (e.g., checks the checkbox of) the wood planks from the product list. The representative then proceeds to guide the consumer through the other images of the deck and/or the various images associated with other product subtypes and customizable features as recommended by the CRM (e.g., in accordance with the prioritized lists of product subtypes and/or customizable features that are resorted in real-time by the CRM and appear in the third user interface as a guide for leading the consumer through the presentation), and the consumer continues to select products that he/she would envision on his/her customized sport yacht.

After the representative guides the consumer through all of the product subtypes on the sport yacht or after the representative determines that a sufficient number of products have been selected to justify a suitable cost-savings to the consumer, the representative directs the consumer to the benefits summary webpage (FIG. 8). On the benefits summary webpage, the consumer is presented with the cost-savings associated with building a custom yacht through the Club, in addition to other benefits provided to members of the Club. The consumer is presented with the costs/benefits of joining the Club as compared to the costs/benefits of joining other yacht clubs, and the representative asks the consumer if the consumer would like to become a member of the Club to take advantage of the cost-savings and additional benefits that the consumer has experienced throughout the presentation. If the consumer expresses an interest in becoming a member of the Club, the consumer is directed to the sign-up webpage (FIG. 9), and the representative gathers any additional information from the consumer that is needed to finalize the consumer's membership account. In other embodiments, the sign-up webpage may facilitate actions other than obtaining payment information, such as, for example, arranging an in-person appointment or a telephone conference between the consumer and the seller.

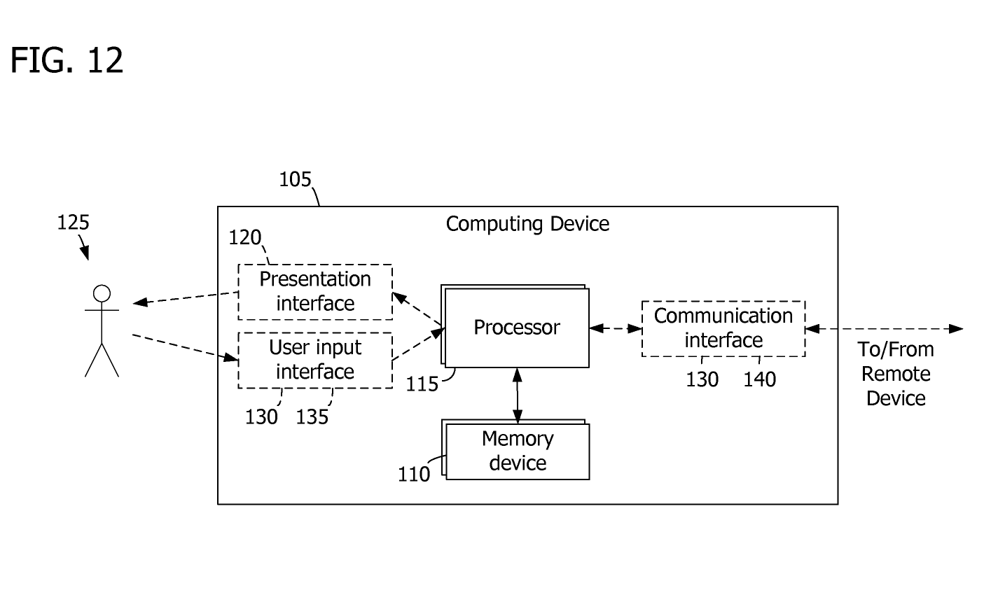

FIG. 12 is a block diagram of an exemplary computing device 905 that may be used by the consumer or the representative to view and/or interact with the presentation as described above. The computing device 905 includes a memory device 910 and a processor 915 coupled to the memory device 910 for executing instructions. In some embodiments, executable instructions are stored in the memory device 910. Computing device 905 is configurable to perform one or more operations described herein by programming the processor 915. For example, the processor 915 may be programmed by encoding an operation as one or more executable instructions and providing the executable instructions in the memory device 910. The processor 915 may include one or more processing units (e.g., in a multi-core configuration).

The memory device 910 is one or more devices that enable information such as executable instructions and/or other data to be stored and retrieved. The memory device 910 may include one or more computer readable storage media, such as, without limitation, dynamic random access memory (DRAM), static random access memory (SRAM), a solid state disk, and/or a hard disk. The memory device 910 may be configured to store, without limitation, interaction data, product data, and/or any other type of data.

In some embodiments, the computing device 905 includes a presentation interface 920 that is coupled to the processor 915. The presentation interface 920 presents information, such as a user interface (e.g., one or more webpages) or product information to a consumer/representative 925. For example, the presentation interface 920 may include a display adapter (not shown in FIG. 9) that may be coupled to one or more display devices, such as a cathode ray tube (CRT), a liquid crystal display (LCD), an organic LED (OLED) display, and/or an “electronic ink” display. For example, the display device(s) may provide two-dimensional and/or three-dimensional imagery (e.g., three-dimensional, virtual reality glasses). In addition to, or in the alternative, the presentation interface 920 may include an audio output device (e.g., an audio adapter and/or a speaker) and/or a printer.

In some embodiments, the computing device 905 includes an input interface 930, such as a user input interface 935 or a communication interface 940. The input interface 930 may be configured to receive any information suitable for use with the methods described herein.

In the exemplary embodiment, the user input interface 935 is coupled to the processor 915 and receives input from the consumer/representative 925. The user input interface 935 may include, for example, a keyboard, a pointing device, a mouse, a stylus, a touch sensitive panel (e.g., a touch pad or a touch screen of a smart-phone), a gyroscope, an accelerometer, a position detector, and/or an audio input interface (e.g., including a microphone). A single component, such as a touch screen, may function as both a display device of the presentation interface 920 and the user input interface 935.

The communication interface 940 is coupled to the processor 915 and is configured to be coupled in communication with one or more remote devices, such as another computing device 905. For example, the communication interface 940 may include, without limitation, a wired network adapter, a wireless network adapter, and/or a mobile telecommunications adapter. The communication interface 940 may also transmit data to one or more remote devices. For example, a communication interface 940 of one computing device 905 used by the representative may transmit an indication of one or more selections in the presentation to the communication interface 940 of another computing device 905 used by the consumer, or vice versa. It should be noted that computing device 905 may be any suitable device that is compatible for accessing the Internet or other suitable network on or offline.

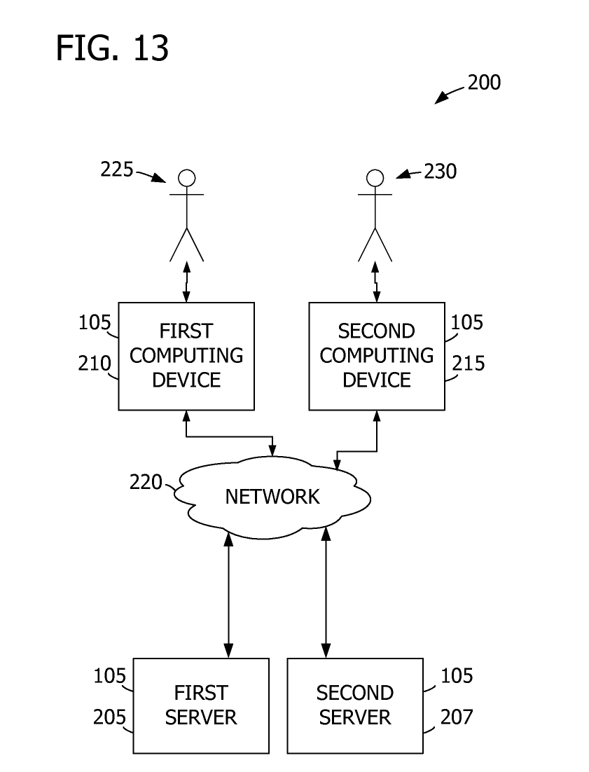

FIG. 13 is block diagram of an exemplary computing system 1000 that may be used with the presentation described above. The system 1000 includes a first server 1005 (e.g., a server for hosting the seller's website), a second server 1007 (e.g., a server for hosting the presentation website), a first computing device 1010 (e.g., a computing device from which the representative views and/or interacts with the presentation website), and a second computing device 1015 (e.g., a computing device from which the consumer views and/or interacts with the seller's website and/or the presentation website) coupled in communication via a network 1020. The network 1020 may include, without limitation, the Internet, a local area network (LAN), a wide area network (WAN), a wireless LAN (WLAN), a mesh network, and/or a virtual private network (VPN).

The first server 1005, the second server 1007, the first computing device 1010, and the second computing device 1015 are computing devices 905 (shown in FIG. 9). In the exemplary embodiment, each computing device 905 is coupled to the network 1020 via the communication interface 940 (shown in FIG. 9). In an alternative embodiment, the first server 1005 and/or the second server 1007 are integrated with the first computing device 1010 (e.g., if the seller hosts the seller's website and the presentation website on the computing device from which the representative views and/or interacts with the presentation website).

The first computing device 1010 interacts with a representative 1025 (e.g., via the user input interface 935 and/or the presentation interface 920). For example, the first computing device 1010 may be configured to receive data relating to the representative 1025 guiding a consumer through the presentation. The first computing device 1010 transmits the data to the second server 1007 via the network 1020. The second server 1007 receives and stores the data from the representative 1025 (e.g., in the memory device 910).

The second computing device 1015 interacts with a consumer 1030 (e.g., via the user input interface 935 and/or the presentation interface 920). For example, the second computing device 1015 may receive data from, and/or present data to, the consumer 1030. For example, the second computing device 1015 may present data to the consumer 1030 in response to data received from the representative.

In some embodiments, the first computing device 1010 is remote to the first server 1005 and the second server 1007. For example, the first computing device 1010 may be located at a facility that is geographically removed from the first server 1005 and/or the second server 1007 (i.e., if the third-party representative of the seller is presenting the presentation to consumers, yet the third-party is hosting neither the seller's website nor the presentation website).

As will be appreciated by one skilled in the art and supported by the foregoing specification, the above-described embodiments of the invention may be implemented using any suitable computer programming or engineering techniques including computer software, firmware, hardware, or any combination or subset thereof. Any resulting program, having computer-readable code means, may be embodied or provided within one or more computer-readable media, thereby making a computer program product (i.e., an article of manufacture, according to the discussed embodiments of the invention). The computer readable media may be, for example, but is not limited to, a fixed (hard) drive, diskette, optical disk, magnetic tape, semiconductor memory such as read-only memory (ROM), and/or any transmitting/receiving medium such as the Internet or other communication network or link. The article of manufacture containing the computer code may be made and/or used by executing the code directly from one medium, by copying the code from one medium to another medium, and/or by transmitting the code over a network.

A technical effect of the methods and systems described herein includes at least one of the following: (1) providing a consumer with an interactive, realistic experience of a seller's goods/services without the consumer having to travel to the seller's location to view the goods/services; (2) enabling a representative to guide a consumer through a presentation of a seller's goods/services in a manner that facilitates selling the goods/services to the consumer at the conclusion of the presentation; (3) enabling a representative to guide a consumer through a presentation of a seller's goods/services by presenting the consumer with features of the goods/services in any suitable quantities and in any suitable order that facilitates selling the goods/services to the consumer at the conclusion of the presentation; (4) providing the consumer with a predetermined amount of interactive ability with the presentation website such that the predetermined amount of interactive ability may differ on a webpage-by-webpage basis to suitably limit the consumer's autonomy to explore the virtual environment; (5) enabling a consumer to inquire into information regarding a good/service shown in a virtual environment using indicators (e.g., “hotspots”) provided in the virtual environment; and (6) providing a representative with a presentation strategy that evolves in real-time during a presentation in response to interaction by the consumer/representative during the presentation, thereby increasing the probability that the consumer will purchase goods/services at the conclusion of the presentation.

The methods and systems provided herein therefore facilitate providing a strategic lead capture tool for selectively and personally engaging consumers on a seller's website and seamlessly funneling the consumers directly from the seller's website into an interactive presentation given by a third-party representative of the seller on a third-party website. This immersive marketing platform enables a representative to guide a consumer through a customized visual/audio presentation of a seller's goods/services in a manner that facilitates selling the goods/services to the consumer at the conclusion of the presentation. An easy-to-use presentation builder is provided as an automated system for small to medium sized businesses to customize their own platforms without the need for additional creative costs associated with development of a presentation by a specialized enterprise firm, and the builder is configured to be a stand alone product, whose main function is to enable a seller to give any website the capability to become Immersive. The customer relationship and management tool (CRM) is configured to capture and analyze in real time any relevant analytic data associated with the capturing of leads from the seller's website and/or the presentation of the seller's goods/services to consumers.

While the invention has been described in terms of various specific embodiments, those skilled in the art will recognize that the invention can be practiced with modification within the spirit and scope of the claims.

What is claimed is:

1. A method of presenting a seller's goods or services to a consumer, said method comprising:
engaging the consumer in conversation with a representative of the seller while the consumer is accessing a webpage of the seller on an Internet browser of a consumer computing device; and
directing the Internet browser to a presentation at a time selected by the representative using a representative computing device, wherein the presentation is configured to provide the consumer with information about at least one of goods and services of the seller.

2. A method in accordance with claim 1, wherein the consumer is engaged in conversation with the representative only after the consumer has exhibited predefined behavior while accessing the seller's webpage.

3. A method in accordance with claim 1, further comprising monitoring consumer traffic on the seller's webpage for consumers exhibiting predefined behavior prior to engaging the consumer in conversation.

4. A method in accordance with claim 1, further comprising providing the representative with a list of consumers accessing the seller's webpage.

5. A method in accordance with claim 4, wherein the list identifies each consumer by an Internet Protocol (IP) address for the associated consumer computing device.

6. A method in accordance with claim 4, further comprising indicating to the representative when one of the consumers exhibits predefined behavior while accessing the seller's webpage.

7. A method in accordance with claim 4, further comprising providing the representative with a list of all consumers with whom the representative is currently engaged in at least one of discussion and presentation.
